(19) United States
(12) Patent Application Publication
(10) Pub. No.: US 2008/0178182 A1
(43) Pub. Date: Jul. 24, 2008

(54) Work state returning apparatus, work state returning method, and computer product

(75) Inventors: Hiroyuki Yamashima, Kawasaki (JP); Yukihiro Watanabe, Kawasaki (JP); Kenji Morimoto, Kawasaki (JP); Tatsuya Okano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/987,394

(22) Filed: Nov. 29, 2007

(30) Foreign Application Priority Data
Jan. 24, 2007 (JP) 2007-013862

(51) Int. Cl. G06F 9/46

(52) U.S. Cl. 718/102

(57) ABSTRACT

A computer system has a dual structure including a current system and an auxiliary system. When the current system stops because of server down, a setting module of the auxiliary system acquires an operation log and an operation management procedure from the current system and analyzes the operation log to specify to which part of the operation management procedure has been completed. The setting module performs comparative analysis of the operation log of the current system and communication log. The setting module extracts, from a result of the comparative analysis, information for returning the auxiliary system to a state of work at the stop of the execution of the current system. To resume the stopped work, the setting module sets the information in the auxiliary system.

### BACKGROUND OF THE INVENTION

1. Field of the Invention

The present invention relates generally to an information system including an operation management function for executing cooperative work and an execution control function for controlling the operation management function. The present invention relates more particularly to a work state returning method, a work state returning apparatus, and a computer product for causing a computer of the information system to execute a process of returning, when the execution control function of the information system stops, the information system to a state of work at the stop of the execution control function based on operation history information of the execution control function.

2. Description of the Related Art

Conventionally, in an information technology (IT) system, there is a technology for returning, when work under execution stops because of an unexpected error such as server down (a server is down), the system to a state of the work under execution based on an operation log of a server (see FIG. 22).

Specifically, as shown in FIG. 23, the conventional IT system includes a plurality of operation management servers that respectively operate operation management modules 2, an execution control server that operates an execution control module 1 based on an operation management procedure set by a system administrator or the like in advance, and a communication function 4 that manages communication between the execution server and the operation management server. The operation management modules 2 perform operation management for apparatuses and services. The execution control module 1 controls the respective operation management modules to cooperatively operate.

For example, when the execution control server is down while work for adding servers is executed based on the operation management procedure, a setting module 3 that operates on the execution control server analyzes the operation log and returns the system to a state of work of an operation management procedure (2) under execution at the time of the execution control server down.

Japanese Patent Application Laid-Open No. H6-62077 discloses a technology in which, in a communication system including a host processor and a communication control apparatus, when a temporary failure occurs in the host processor, the host processor gives a transfer request to the communication control apparatus based on a result of comparison between texts stored before and after the occurrence of the failure and a text that the host processor requests the communication control apparatus to send and receives.

The conventional technology cannot efficiently return the system to a state of the work under execution.

For example, the operation management procedure (2) includes a process of securing resources in the server adding work. When the execution control server is down immediately after a resource securing request for adding servers is transmitted from the execution control module 1 to the operation management module 2, the execution control module 1 cannot receive a response from the operation management module 2. Thus, the execution control module 1 cannot judge whether resources are secured by the operation management module 2. Therefore, even if resources are already secured by the operation management module 2, the setting module 3 of the execution control server performs the work in the operation management procedure (2) again from a resource securing request. As a result, since work procedures to be performed again increases, it is impossible to efficiently return the system to a state of the work under execution.

### SUMMARY OF THE INVENTION

It is an object of the present invention to at least partially solve the problems in the conventional technology.

According to an aspect of the present invention, a work state returning apparatus is for enabling recovery of an information system including an operation management function and an execution control function. The operation management function executes work according to an instruction from the execution control function. The execution control function controls the operation management function to execute the work based on operation management information defining work content and work order for the work. The apparatus includes a communication-history-information acquiring unit that acquires, when the operation management function executes the work according to the instruction from the execution control function, communication history information concerning communication performed between the operation management function and the execution control function; a communication-history-information storing unit that stores therein the communication history information acquired by the communication-history-information acquiring unit; a returning-part specifying unit that specifies, when the execution control function stops while the work is executed by the operation management function, a returning location in the work content and the work order, based on operation history information of the execution control function and the communication history information stored in the communication-history-information storing unit; and a work-state returning unit that returns, according to the returning location specified by the returning-part specifying unit, the information system to a state of work at the stop of the execution control function.

According to another aspect of the present invention, a work state returning method is for enabling recovery of an information system including an operation management function and an execution control function. The operation management function executes work according to an instruction from the execution control function. The execution control function controls the operation management function to execute the work based on operation management information defining work content and work order for the work. The method causes a computer to execute acquiring, when the operation management function executes the work according to the instruction from the execution control function, communication history information concerning communication performed between the operation management functions and the execution control function; storing the communication history information; specifying, when the execution control function stops while the work is executed by the operation management function, a returning location in the work content and the work order, based on operation history information of the execution control function and the communication history information; and returning, according to the returning location, the information system to a state of work at the stop of the execution control function.

According to still another aspect of the present invention, a computer-readable recording medium stores therein a computer program that implements the above method on the computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an overview and characteristics of an information system according to a first embodiment of the present invention;

FIG. 2 is a diagram of the information system according to the first embodiment;

FIG. 3 is a diagram of an example of an operation management procedure according to the first embodiment;

FIG. 4 is a diagram of an example of description of the operation management procedure according to the first embodiment;

FIG. 5 is a diagram of an example of the structure of an operation log according to the first embodiment;

FIG. 6 is a diagram of an example of the structure of a communication log according to the first embodiment;

FIG. 7 is a diagram of the structure of a setting module according to the first embodiment;

FIG. 8 is a sequence chart for explaining a flow of processing of the information system according to the first embodiment;

FIGS. 9A and 9B are diagrams of an example of an operation management procedure according to a second embodiment of the present invention;

FIG. 10 is a diagram of an example of description of the operation management procedure according to the second embodiment;

FIG. 11 is a diagram of an example of description of the operation management procedure according to the second embodiment;

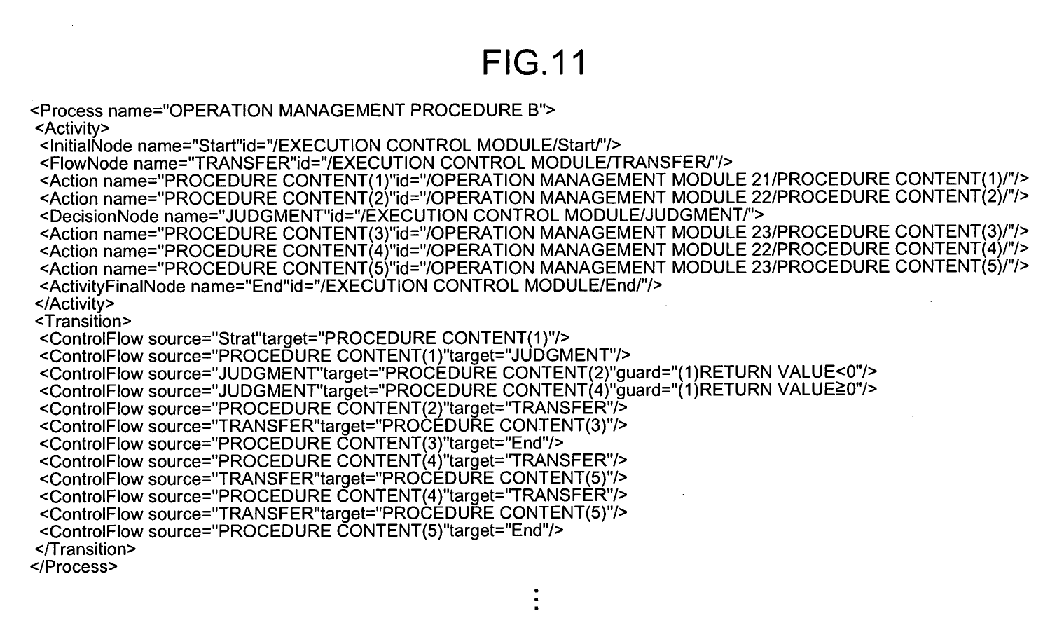

FIG. 12 is a diagram of an example of the structure of an operation log according to the second embodiment;

FIG. 13 is a diagram of an example of the structure of a communication log according to the second embodiment;

FIG. 14 is a diagram of the structure of a setting module according to the second embodiment;

FIG. 15 is a sequence chart for explaining a flow of processing of an information system according to the second embodiment;

FIG. 16 is a sequence chart for explaining a flow of processing of the information system according to the second embodiment;

FIG. 17 is a diagram of an information system according to a third embodiment of the present invention;

FIG. 18 is a diagram of the structure of a state management module according to the third embodiment;

FIG. 19 is a diagram of an example of the structure of information managed by the state management module according to the third embodiment;

FIG. 20 is a sequence chart for explaining a flow of processing of the information system according to the third embodiment;

FIG. 21 is a sequence chart for explaining a flow of processing of the information system according to the third embodiment;

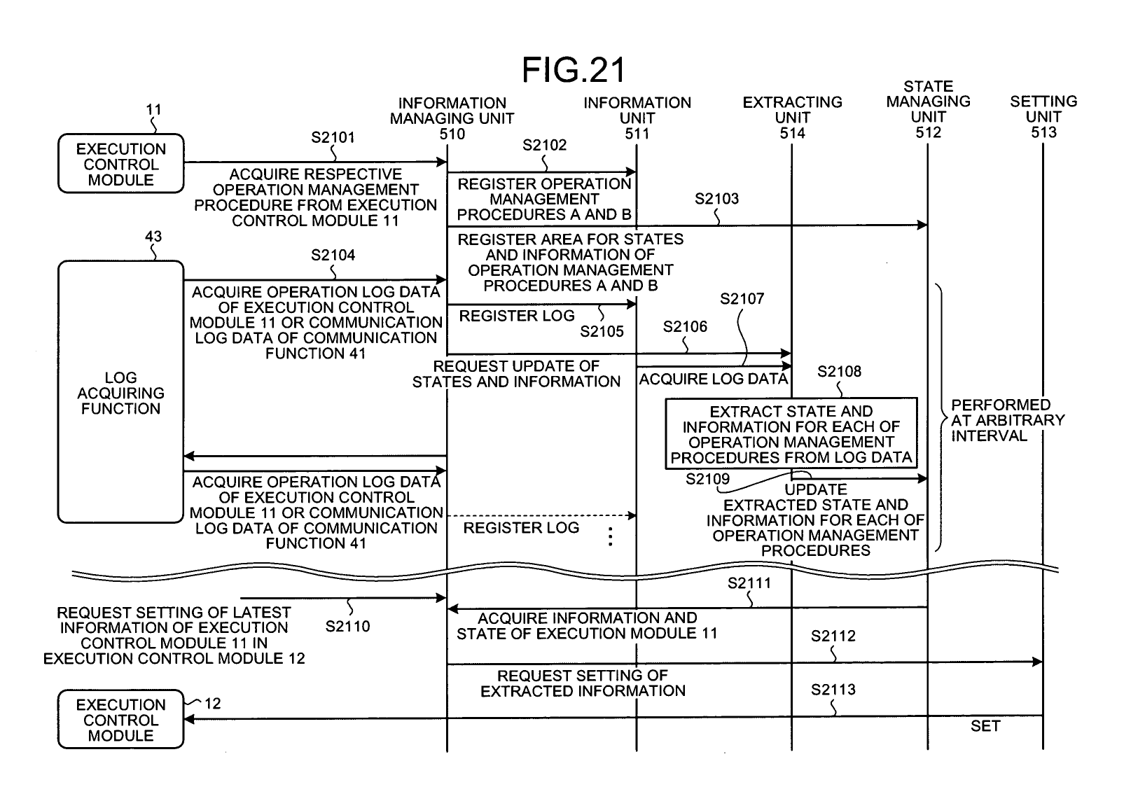

FIG. 22 is a diagram of the conventional information system; and

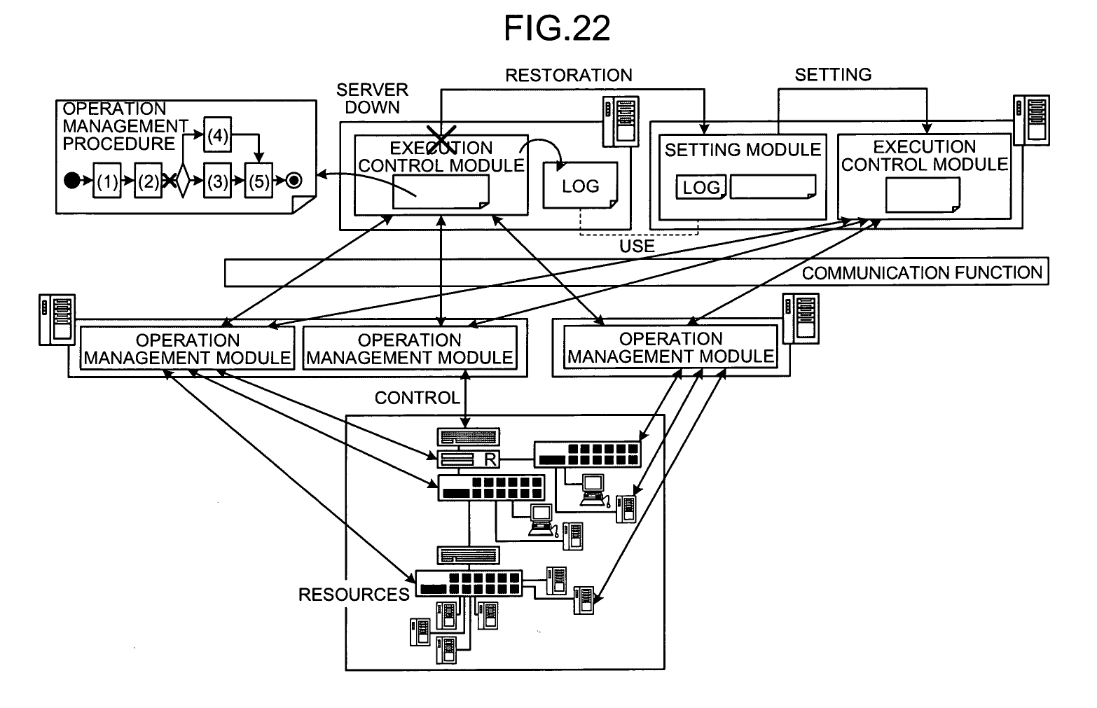

FIG. 23 is a diagram for explaining the conventional information system.

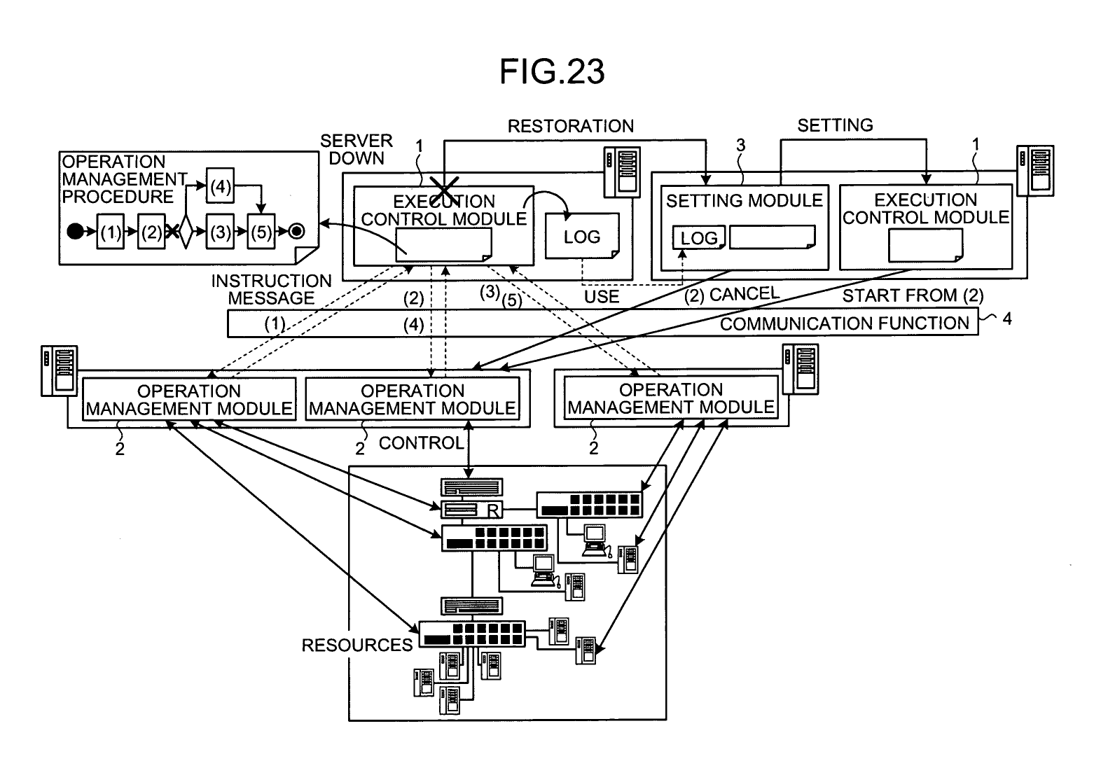

### DETAILED DESCRIPTION OF THE PREFERRED EMBODIMENTS

Exemplary embodiments of the present invention are explained in detail below with reference to the accompanying drawings.

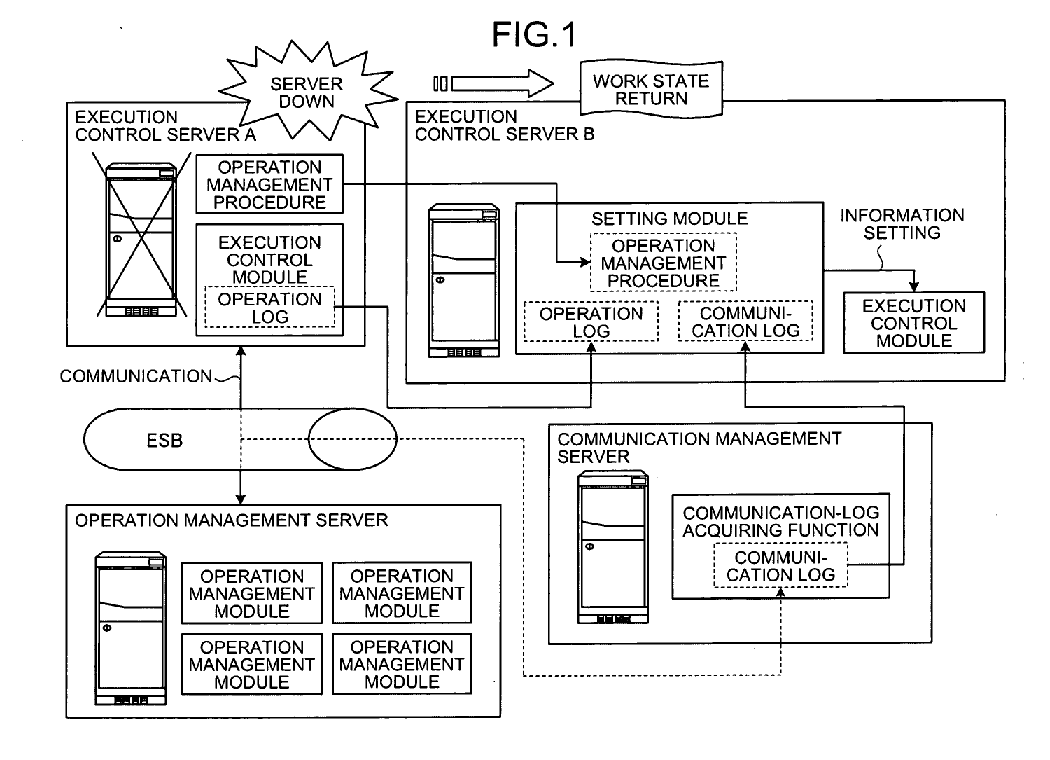

FIG. 1 is a diagram for explaining an overview and characteristics of an information system according to a first embodiment of the present invention.

The information system according to the first embodiment includes an execution control server, an operation management server, and a communication management server. The operation management server operates, based on an operation management procedure in which work content and work order are set, an execution control module for controlling respective operation management modules to cooperatively work. The operation management server operates respective operation management modules that execute cooperative work according to an instruction from the execution control module. The communication management server acquires a log concerning contents of communication performed between the execution control server and the operation management server (a communication log) via, for example, an enterprise service bus (ESB).

The execution control server has a dual structure including an execution control server A of a current system and an execution control server B of an auxiliary system for starting, when the execution control server A is down and the execution control module stops, a new execution control module to recover the function of the execution control module. The present invention is not limited to the dual structure including the execution control servers. A new server can be set instead of the down server or a server having a recovery function can be originally set.

With such a structure, when the execution control module stops, the information system according to the first embodiment returns, based on an operation log of the execution control module that controls the respective operation management modules based on the operation management procedure, the system to a state of work at the stop of the execution control module. The information system has a main characteristic that it is possible to efficiently return a state of work that stops because of unexpected occurrence of a failure or the like to a state of the work under execution.

As shown in FIG. 1, in the information system according to the first embodiment, when the execution control server A is down because of an unexpected error or the like and, therefore, the execution control module operating on the execution control server A stops, the execution control server B as the auxiliary system for the execution control server A returns the system to a state of work at the stop of the execution control module of the execution control server A.

Specifically, a setting module of the execution control server B acquires an operation log and an operation management procedure from the execution control server A and performs analysis of the operation log to specify to which extent of the operation management procedure work has been completed at the point when the execution control module stops. According to the analysis of the operation log, for example, it is specified that the work has been completed up to work content 1 of an operation management procedure (2) including the work content 1 and work content 2.

The setting module of the execution control server B acquires a communication log concerning communication performed between the execution control server and the operation management server from the communication control server and performs comparative analysis of a result of the analysis of the operation log of the execution control server A and the communication log.

For example, the work content 1 of the operation management procedure (2) is transmission of a request for starting an apparatus from the execution control module to the operation management module, the work content 2 of the operation management procedure (2) is confirmation of a reply message from the operation management module by the execution control module, and the reply message from the operation management module is written in a communication log. In such a case, the setting module of the execution control server B performs the comparative analysis as described below.

The work up to the work content 1 of the operation management procedure (2) has been completed at the point when the execution control module of the execution control server A stops. Thus, the setting module of the execution control server B derives from the comparative analysis that the reply message from the operation management module used in the work content 2 of the operation management procedure (2) is not received by the execution control module of the execution control server A.

The setting module of the execution control server B extracts, from a result of the comparative analysis, information for returning the system to a state of work at the stop of the execution control module of the execution control server A. The setting module of the execution control server B sets the information in an execution control module started anew in the execution control server B. For example, as the information for returning the system to a state of work at the stop of the execution control module of the execution control server A, there are information on a reply message from the operation management server, information on a part or step to which the system is returned (hereinafter, “returning part”) in the operation management procedure, and the like.

After receiving the setting of the information from the setting module, the execution control module started anew in the execution control server B succeeds the execution control module of the execution control server A and executes the work based on the operation management procedure. In this way, the information system according to the first embodiment returns to the state of work at the point when the execution control module of the execution control server A stops.

Consequently, the information system according to the first embodiment can efficiently return a state of work that stops because of unexpected occurrence of a failure or the like to a state of the work under execution.

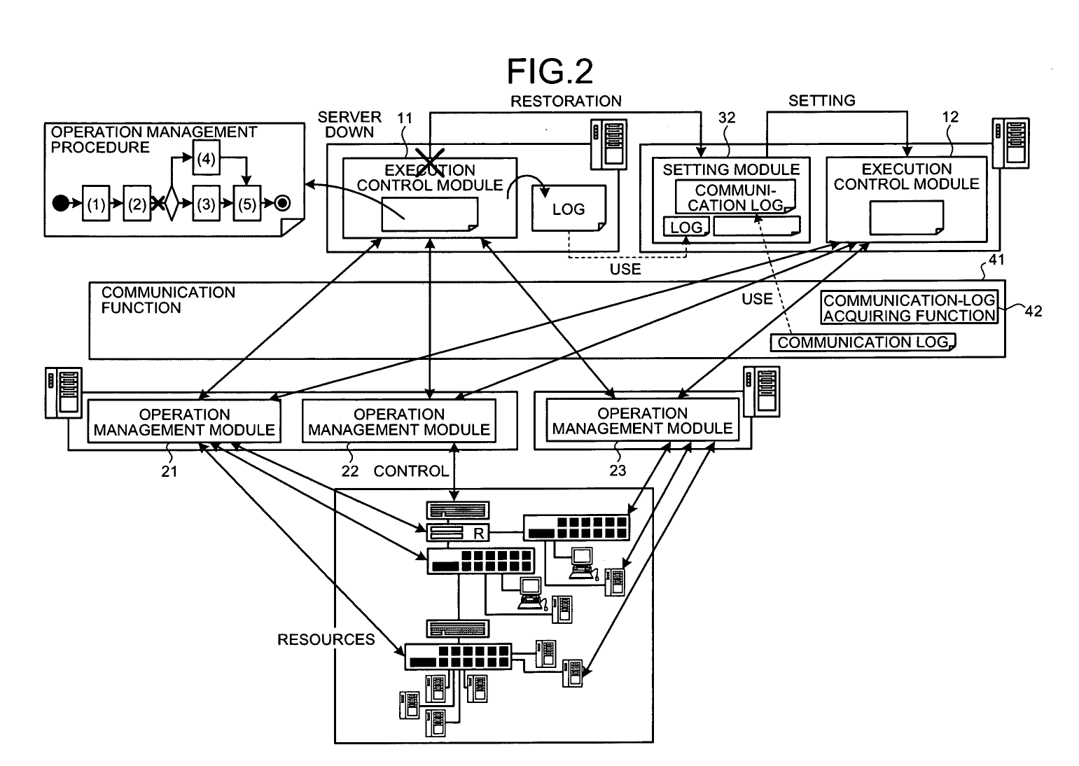

FIG. 2 is a diagram of the information system according to the first embodiment.

As shown in FIG. 2, the information system according to the first embodiment includes execution control modules 11 and 12 that operate on an apparatus such as a server, operation management modules 21, 22, and 23, a setting module 32, a communication function 41, and a communication-log acquiring function 42.

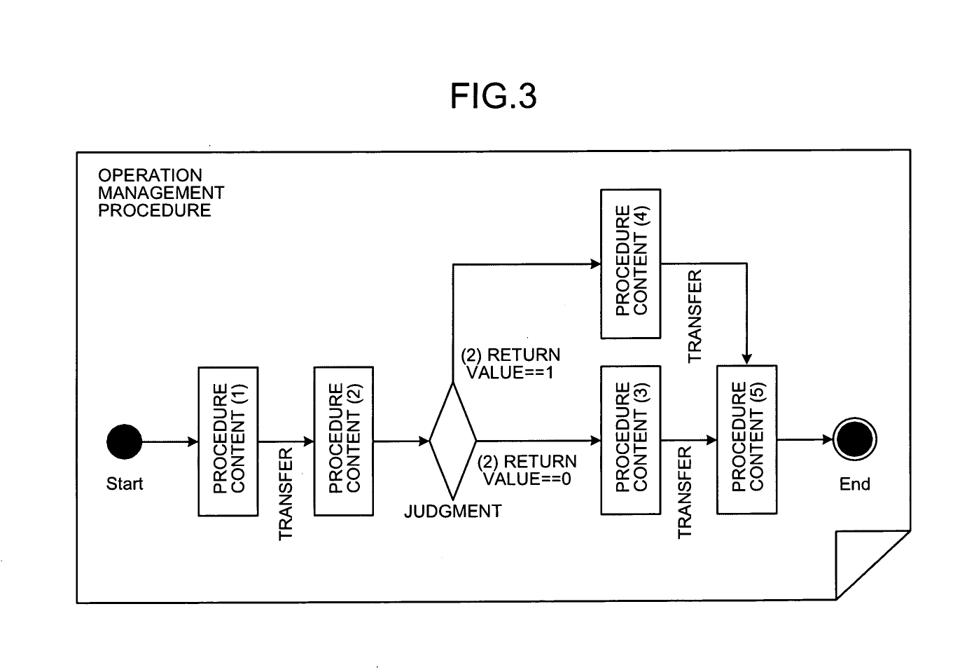

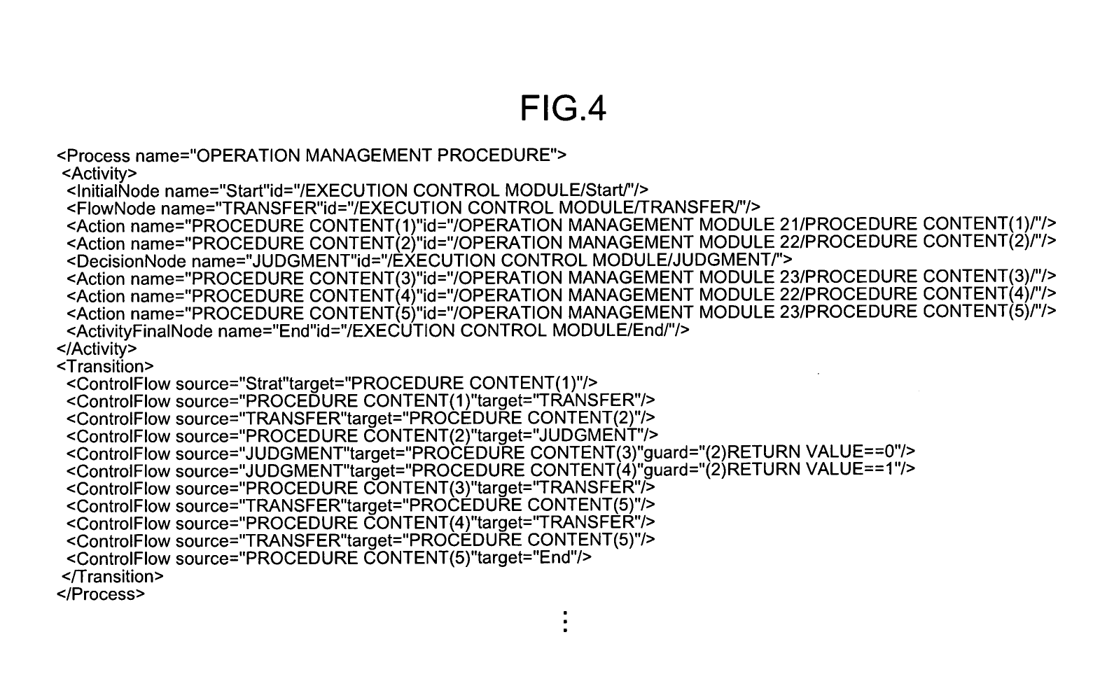

The execution control module 11 controls, based on an operation management procedure in which work content and work order are set (see FIGS. 3 and 4), the respective operation management modules to perform cooperative work. For example, the execution control module 11 judges the next work procedure based on the work order set in the operation management procedure and a return value and system configuration information from the operation management module and writes operation content as an operation log. The execution control module 12 is a module started anew when the execution control module 11 stops.

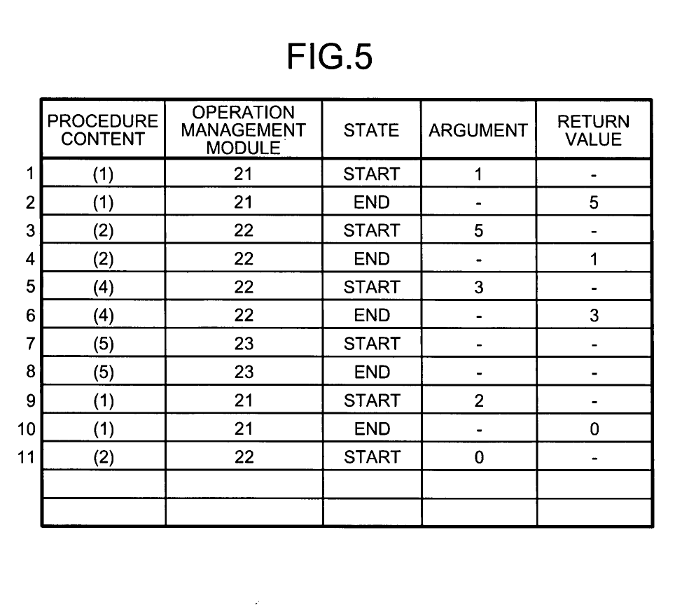

As shown in FIG. 5 as an example, the operation log is configured to record procedure content set in the operation management procedure, an operation management module that executes work corresponding to a procedure, a state of an execution control module, an argument, and a return value in association with one another.

The operation management modules 21, 22, and 23 execute cooperative work according to an instruction from the execution control module. For example, the operation management modules 21, 22, and 23 performs setting of resources of services provided by the information system and software such as application software and management of states of the resources and the software.

The communication function 41 performs communication between the execution control module and the operation management module. The communication-log acquiring function 42 acquires a log concerning content of communication performed between the execution control module and the operation management module (a communication log).

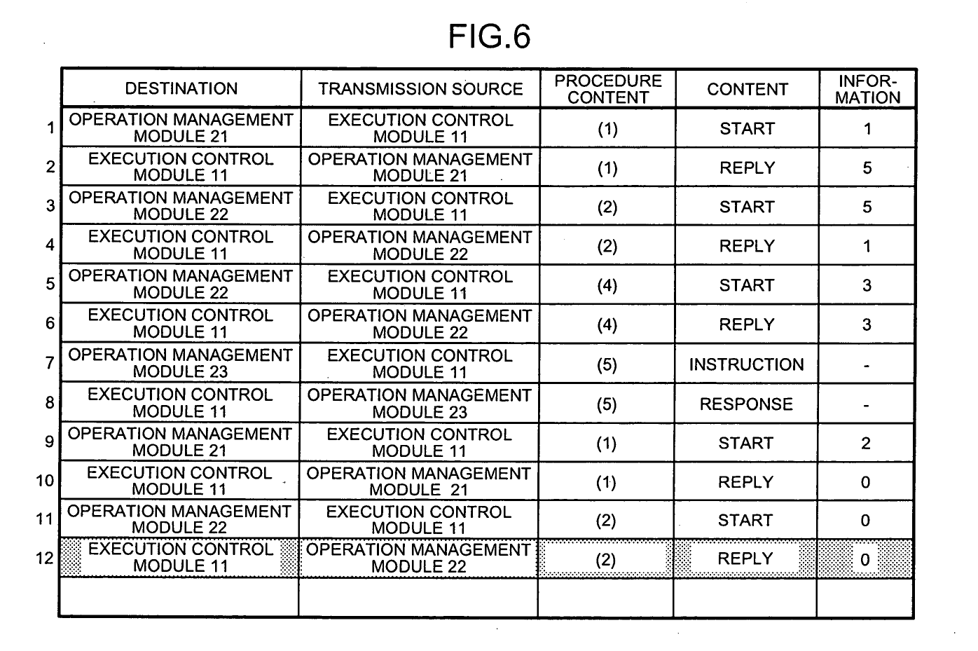

As shown in FIG. 6 as an example, the communication log includes a destination and a transmission source of the communication performed between the execution control module and the operation management module, a number indicating procedure content of the operation management procedure, content of the communication, and information on an argument or a return value in association with one another.

The communication function 41 and the communication-log acquiring function 42 are realized by using, for example, an enterprise service bus (ESB). The ESB is a high-function processing program based on a service-oriented architecture (SOA), which is a system architecture for causing software departments and functions to flexibly cooperate with one another according to a unit of a service process. Systems (for example, an execution control system and an operation management system) can be configured to exchange data through the ESB, which is a virtual message bus.

The setting module 32 extracts, based on the operation log acquired from the execution control module that stops because of server down or the like and the communication log acquired from the communication-log acquiring function 42, information on a returning part, location or step in the operation management procedure and a return state value. The setting module 32 sets the information and the return state value in an execution control module started anew instead of the execution control module that stops.

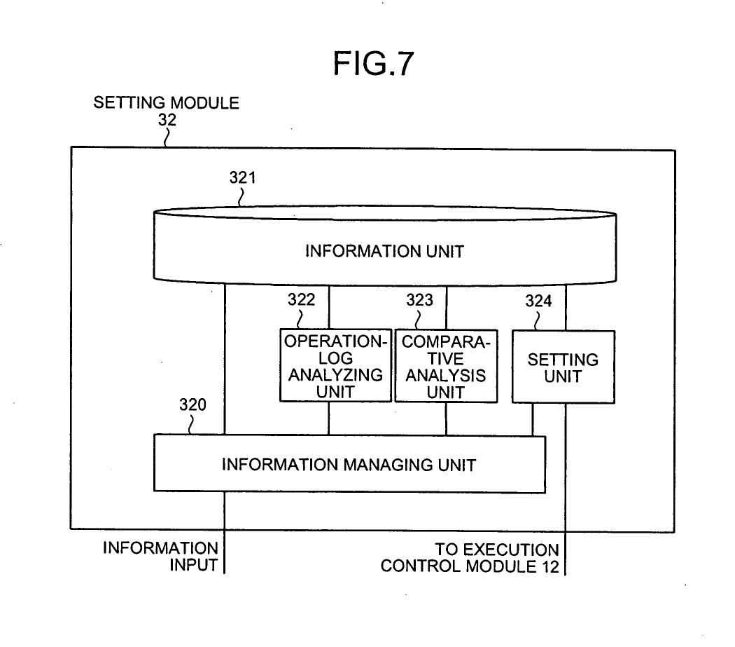

As shown in FIG. 7, the setting module 32 includes an information managing unit 320, an information unit 321, an operation-log analyzing unit 322, a comparative analysis unit 323, and a setting unit 324.

The information managing unit 320 acquires the operation log and the operation management procedure of the execution control module that stops because of server down, acquires the communication log from the communication-log acquiring function 42, and registers the operation log, the operation management procedure, and the communication log in the information unit 321. The information managing unit 320 transmits an operation log analysis instruction to the operation-log analyzing unit 322 and receives an operation log analysis result from the operation-log analyzing unit 322.

The information managing unit 320 receives the analysis result from the operation-log analyzing unit 322. The information managing unit 320 transmits an instruction for comparative analysis of the operation log analysis result and the communication log to the comparative analysis unit 323 and receives a comparative analysis result from the comparative analysis unit 323. The information managing unit 320 extracts information for returning the system to a state of work at the stop of the execution control module (e.g., information on a return value and a returning part in the operation management procedure received from the operation management module) from the comparative analysis result. The information managing unit 320 requests the setting unit 324 to set the extracted information in an execution control module started anew.

The information unit 321 receives registration of the information (the operation management procedure, the operation log, and the communication log) from the information managing unit 320. The operation-log analyzing unit 322 receives the instruction from the information managing unit 320. The operation-log analyzing unit 322 acquires the operation management procedure and the operation log from the information unit 321 and analyzes the operation log. For example, when the operation management procedure (2) includes the work content 1 and the work content 2, according to the analysis of the operation log by the operation-log analyzing unit 322, it is specified that the work up to the work content 1 of the operation management procedure (2) has been completed (e.g., 11 in FIG. 5 indicates the work content 1). The operation-log analyzing unit 322 transmits a result of the operation log analysis to the information managing unit 320.

The comparative analysis unit 323 receives the instruction from the information managing unit 320. The comparative analysis unit 323 acquires the communication log from the information unit 321 and performs comparative analysis of the operation log analysis result and the communication log. For example, the work content 1 of the operation management procedure (2) is transmission of a request for starting an apparatus from the execution control module to the operation management module, the work content 2 of the operation management procedure (2) is confirmation of a replay message from the operation management module by the execution control module, and the replay message from the operation management module is written in the communication log (e.g., 12 in FIG. 6). In such a case, the comparative analysis unit 323 performs the comparative analysis as described below.

The work up to the work content 1 of the operation management procedure (2) has been completed at the point when the execution control module of the execution control server A stops. Thus, the comparative analysis unit 323 derives from the comparative analysis that the reply message from the operation management module used in the work content 2 of the operation management procedure (2) is not received by the execution control module of the execution control server A. The comparative analysis unit 323 transmits a result of the comparative analysis to the information managing unit 320.

The setting unit 324 receives the request from the information managing unit 320. The setting unit 324 sets, in the execution control module started anew, information for returning the system to a state of work at the stop of the execution control module.

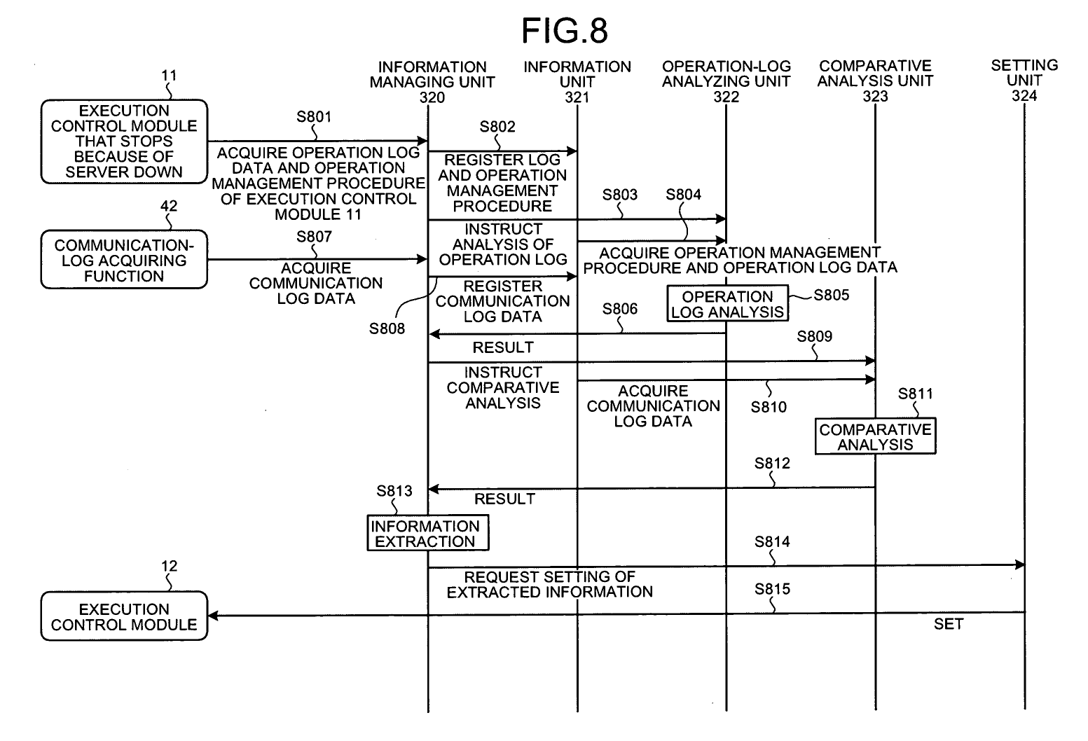

FIG. 8 is a sequence chart for explaining a flow of processing of the information system according to the first embodiment.

For example, when the execution control module 11 stops because of server down, the information managing unit 320 of the setting module 32 mounted on the server of the auxiliary system for the down server acquires operation log data and an operation management procedure of the execution control module 11 (step S801) and registers the operation log data and the operation management procedure in the information unit 321 (step S802). The information managing unit 320 transmits an operation log analysis instruction to the operation-log analyzing unit 322 (step S803).

The operation-log analyzing unit 322 receives the instruction from the information managing unit 320. The operation-log analyzing unit 322 acquires the operation management procedure and the operation log data from the information unit 321 (step S804) and performs operation log analysis (step S805). For example, when the operation management procedure (2) includes the work content 1 and the work content 2, according to the analysis of the operation log by the operation log analyzing unit 322, it is specified that the work up to the work content 1 of the operation management procedure (2) has been completed. The operation-log analyzing unit 322 transmits a result of the operation log analysis to the information managing unit 320 (step S806).

The information managing unit 320 acquires communication log data from the communication-log acquiring function 42 (step S807) and registers the communication log data in the information unit 321 (step S808).

The information managing unit 320 receives the operation log analysis result from the operation-log analyzing unit 322. The information managing unit 320 transmits an instruction for comparative analysis of the operation log analysis result and the communication log to the comparative analysis unit 323 (step S809). The comparative analysis unit 323 receives the instruction from the information managing unit 320. The comparative analysis unit 323 acquires the communication log data from the information unit 321 (step S810) and performs comparative analysis of the operation log analysis result and the communication log (step S811).

For example, the work content 1 of the operation management procedure (2) is transmission of a request for starting an apparatus from the execution control module to the operation management module, the work content 2 of the operation management procedure (2) is confirmation of a reply message from the operation management module by the execution control module, and the reply message from the operation management module is written in a communication log. In such a case, the comparative analysis unit 323 performs the comparative analysis as described below.

The work up to the work content 1 of the operation management procedure (2) has been completed at the point when the execution control module of the execution control server A stops. Thus, the comparative analysis unit 323 derives from the comparative analysis that the reply message from the operation management module used in the work content 2 of the operation management procedure (2) is not received by the execution control module of the execution control server A. The comparative analysis unit 323 transmits a result of the comparative analysis to the information managing unit 320 (step S812).

The information managing unit 320 receives the comparative analysis result from the comparative analysis unit 323. The information managing unit 320 extracts information for returning the system to a state of work at the stop of the execution control module (e.g., information on a return value and a returning part in the operation management procedure received from the operation management module) from the comparative analysis result (step S813). The information managing unit 320 requests the setting unit 324 to set the extracted information in an execution control module started anew (step S814).

The setting unit 324 receives the request from the information managing unit 320. The setting unit 324 sets the information for returning the system to a state of work at the stop of the execution control module (step S815).

As described above, according to the first embodiment, when the respective operation management modules execute cooperative work according to an instruction from the execution control module, log data of communication performed between the respective operation management modules and the execution control module is acquired and registered. When the execution control module stops while the cooperative work is executed by the respective operation management modules, returning parts or locations in work content and work order set in an operation management procedure is specified based on the communication log data and operation log data registered. Then, according to the specified returning location, the system is returned to a state of work at the stop of the execution control module. Therefore, it is possible to efficiently return a state of work that stops because of unexpected occurrence of a failure or the like to a state of the work under execution. For example, when the execution control module stops immediately after an apparatus start request is transmitted from the execution control module to the management operation module, a response from the operation management module is not received by the execution control module. In such a case, information on the reply message acquired from the communication log data can be set in an execution control module started anew instead of the execution control module that stops. Therefore, it is unnecessary to perform confirmation of the reply message again in the execution control module started anew and it is possible to efficiently return the system to a state of the work under execution (e.g., work after confirmation of the reply message).

In the first embodiment, a plurality of operation management procedures can be executed in the information system.

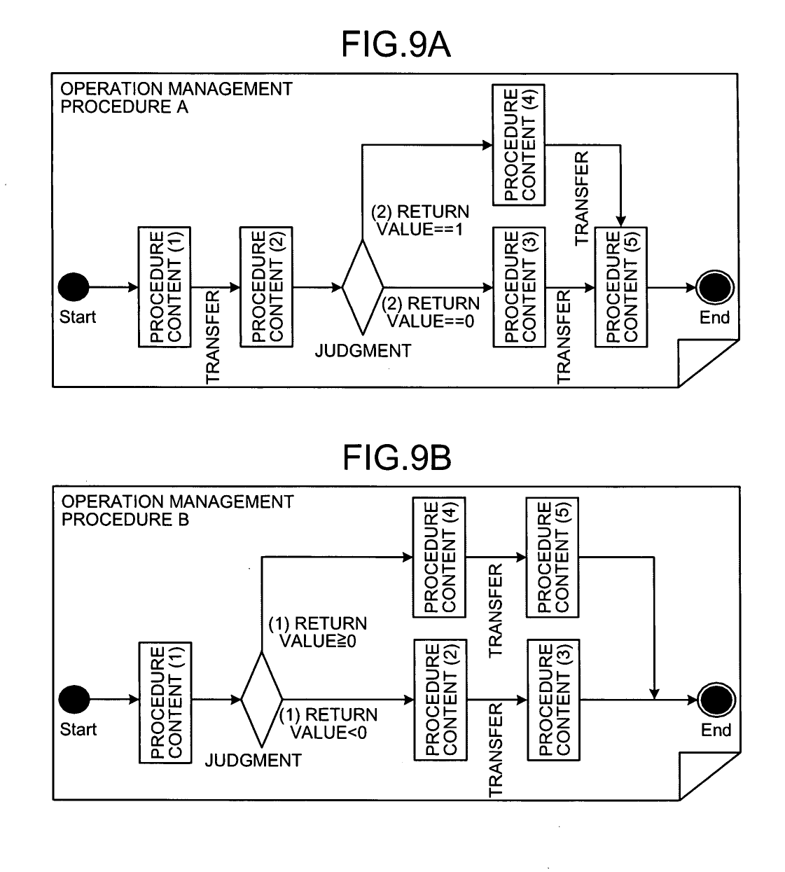

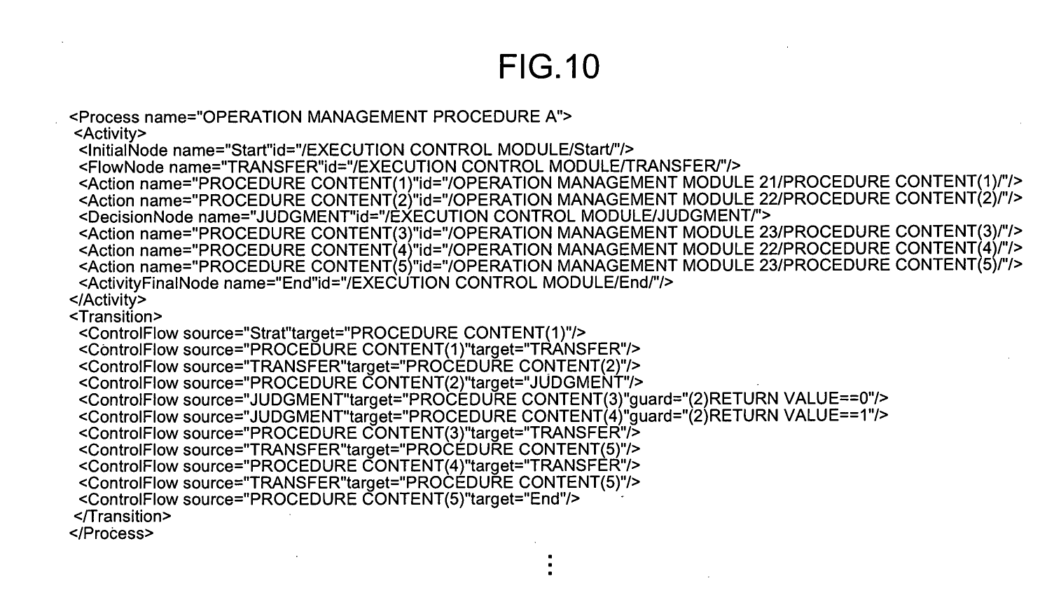

In an information system according to a second embodiment of the present invention, the execution control module 11 (see FIG. 2) controls, based on a plurality of operation management procedures (see, for example, FIGS. 9A, 9B, and 10) in which work content and work orders are set, the respective operation management modules 21, 22, and 23 (see FIG. 2) to cooperatively work.

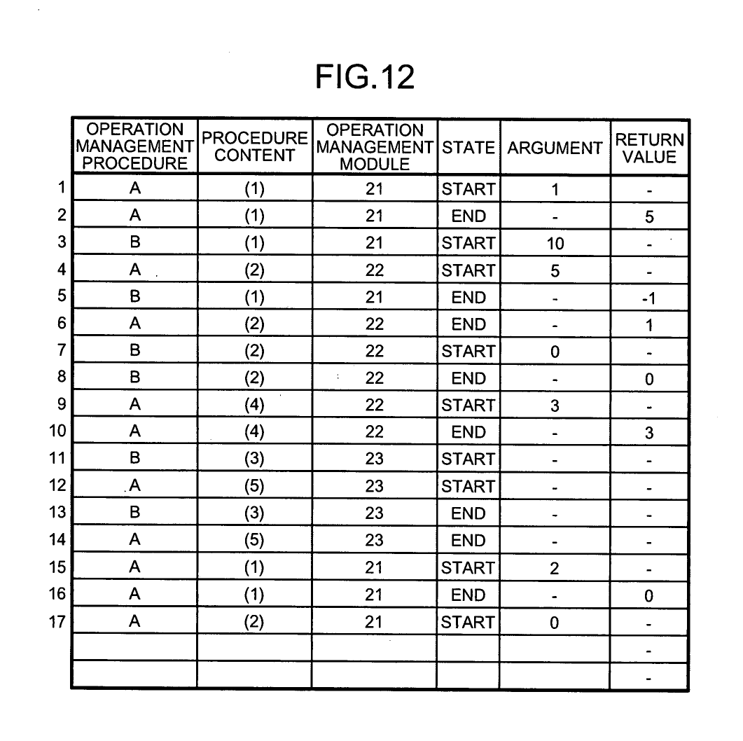

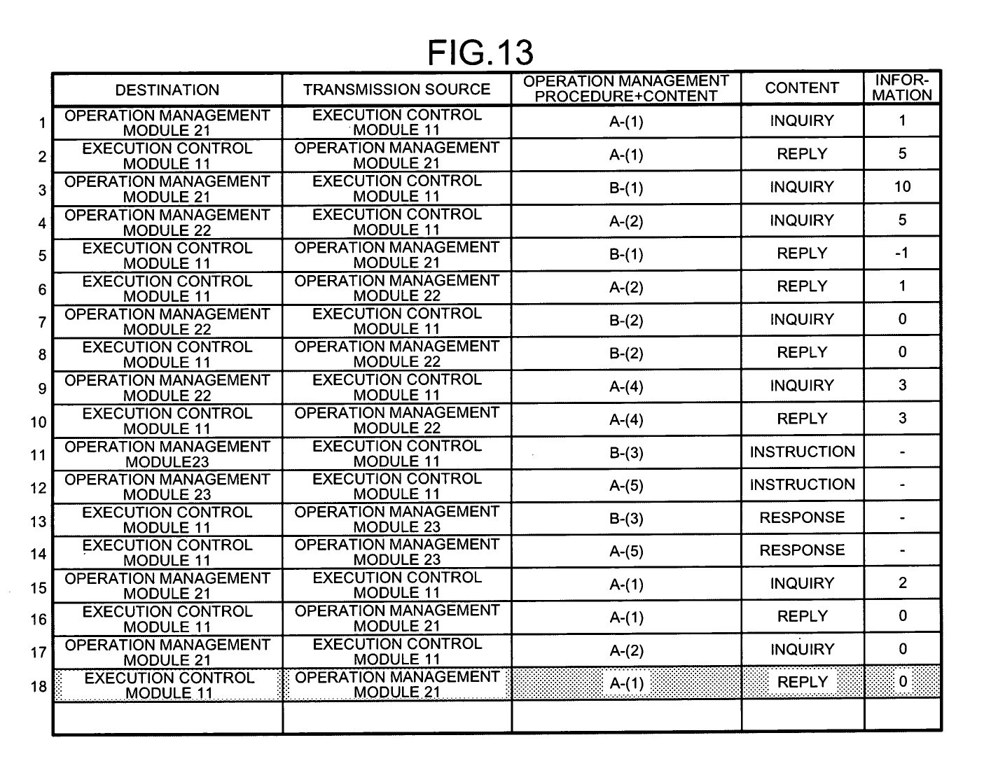

As shown in FIG. 12 as an example, the execution control module 11 of the information system according to the second embodiment writes identification information (e.g., “A” and “B”) for identifying respective operation management procedures (e.g., an operation management procedure A and an operation management procedure B) together with an operation log to make it clear which operation management procedure includes procedure content corresponding to the work executed by the respective operation management modules 21, 22, and 23. As shown in FIG. 13 as an example, the communication-log acquiring function 42 of the information system according to the second embodiment acquires identification information for identifying the operation management procedures in addition to numbers indicating procedure contents of the operation management procedures.

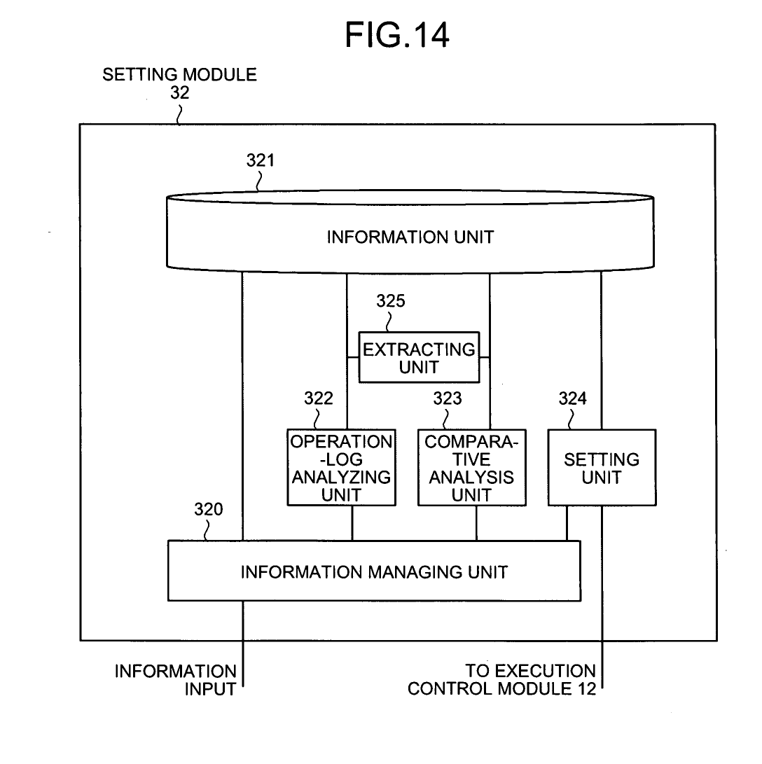

The setting module 32 of the information system according to the second embodiment has the structure (processing function) basically the same as that of the setting module 32 of the information system according to the first embodiment but includes, as shown in FIG. 14, an extracting unit 325 anew.

The operation-log analyzing unit 322 receives the instruction from the information managing unit 320. Then, the operation-log analyzing unit 322 transmits, for example, a request for acquisition of operation log data of the operation management procedure B to the extracting unit 325. The extracting unit 325 acquires the operation management procedure B and the operation log data of the operation management procedure B from the information unit 321 and transmits the operation management procedure B and the operation log data to the operation-log analyzing unit 322.

The operation-log analyzing unit 322 performs operation log analysis for the operation management procedure B and the operation log data of the operation management procedure B. As a result of the operation log analysis, when it is found that work for the operation management procedure B has not stopped in the middle, the operation-log analyzing unit 322 transmits, for example, a request for acquisition of operation log data of the operation management procedure A to the extracting unit 325. The extracting unit 325 acquires the operation management procedure A and the operation log data of the operation management procedure A from the information unit 321 and transmits the operation management procedure A and the operation log data to the operation-log analyzing unit 322.

The operation-log analyzing unit 322 performs operation log analysis for the operation management procedure A and the operation log data of the operation management procedure A. As a result of the operation log analysis, when it is found that work for the operation management procedure A has stopped in the middle, the operation-log analyzing unit 322 transmits a result of the operation log analysis for the operation management procedure A and the operation log data of the operation management procedure A to the information managing unit 320.

The information managing unit 320 transmits an instruction for comparative analysis of the operation log analysis result and the communication log for the operation management procedure A to the comparative analysis unit 323.

The comparative analysis unit 323 receives the instruction from the information managing unit 320. The comparative analysis unit 323 transmits, for example, a request for acquisition of the communication log data of the operation management procedure A to the extracting unit 325. The extracting unit 325 acquires the communication log data of the operation management procedure A from the information unit 321 and transmits the communication log data to the comparative analysis unit 323.

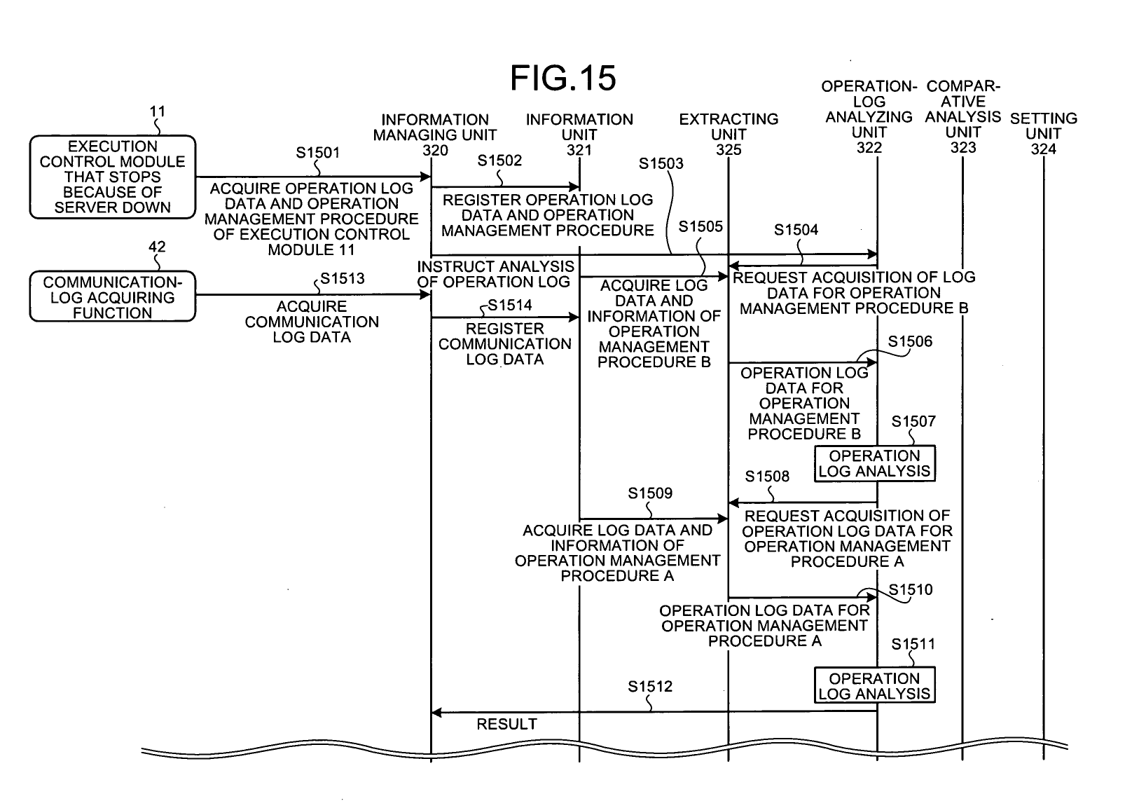

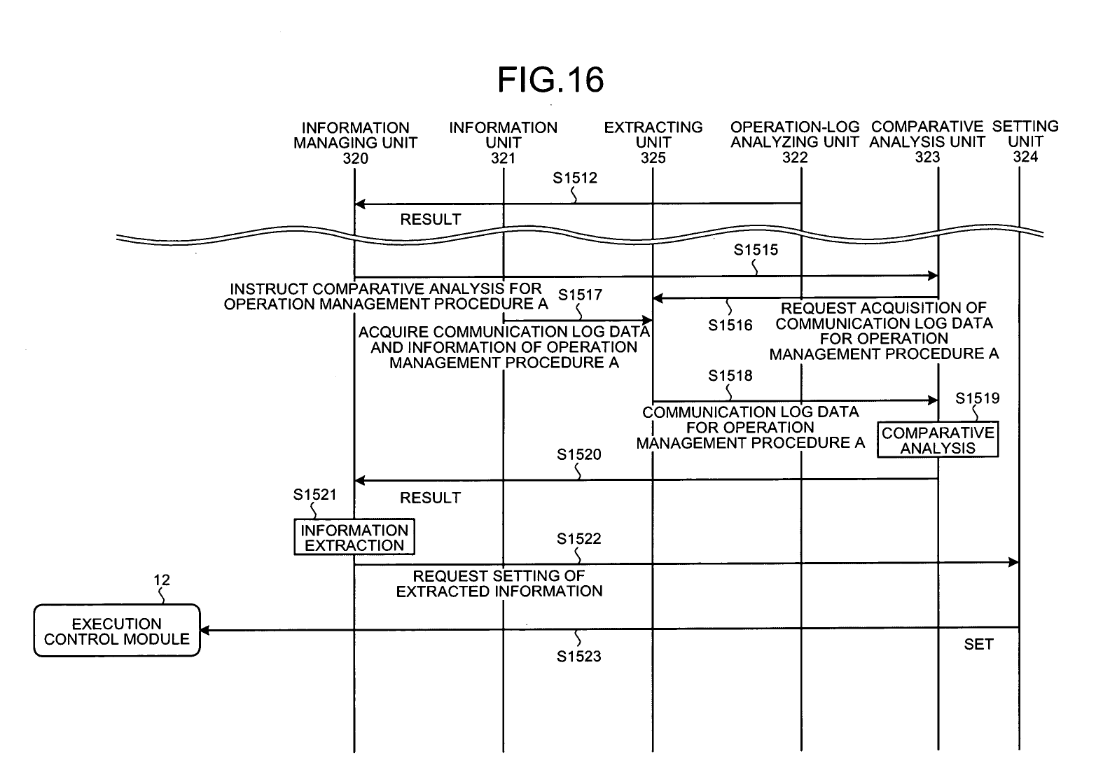

FIGS. 15 and 16 are sequence charts for explaining a flow of processing of the information system according to the second embodiment. The processing of the information system according to the second embodiment is basically the same as the processing of the information system according to the first embodiment except points explained below.

The operation-log analyzing unit 322 receives the instruction from the information managing unit 320. Then, the operation-log analyzing unit 322 transmits, for example, a request for acquisition of operation log data of the operation management procedure B to the extracting unit 325 (step S1504). The extracting unit 325 acquires the operation management procedure B and the operation log data of the operation management procedure B from the information unit 321 (step S1505) and transmits the operation management procedure B and the operation log data to the operation-log analyzing unit 322 (step S1506).

The operation-log analyzing unit 322 performs operation log analysis for the operation management procedure B and the operation log data of the operation management procedure B (step S1507). As a result of the operation log analysis, when it is found that work for the operation management procedure B has not stopped in the middle, the operation-log analyzing unit 322 transmits, for example, a request for acquisition of the operation log data of the operation management procedure A to the extracting unit (step S1508). The extracting unit 325 acquires the operation management procedure A and the operation log data of the operation management procedure A from the information unit 321 (step S1509) and transmits the operation management procedure A and the operation log data of the operation management procedure A to the operation-log analyzing unit 322 (step s1510).

The operation-log analyzing unit 322 performs operation log analysis for the operation management procedure A and the operation log data of the operation management procedure A (step S1511). As a result of the operation log analysis, when it is found that the work for the operation management procedure A has stopped in the middle, the operation-log analyzing unit 322 transmits a result of the operation log analysis for the operation management procedure A and the operation log data for the operation management procedure A to the information managing unit 320 (step S1512).

The information managing unit 320 transmits an instruction for comparative analysis of the operation log analysis result and communication log for the operation management procedure A to the comparative analysis unit 323 (step S1515).

The comparative analysis unit 323 receives the instruction from the information managing unit 320. The comparative analysis unit 323 transmits, for example, a request for acquisition of the communication log data of the operation management procedure A to the extracting unit 325 (step S1516). The extracting unit 325 acquires the communication log data of the operation management procedure A from the information unit 321 (step S1517) and transmits the communication log data to the comparative analysis unit 323 (step S1518).

As described above, according to the second embodiment, the operation log data and the communication log data include identification information (e.g., “A” and “B”) given to the respective operation management procedures (e.g., the operation management procedure A and the operation management procedure B) to uniquely identify the operation management procedures. When the execution control module stops while cooperative work is executed by the respective operation management modules, the operation log data and the communication log data are extracted for each piece of the identification information. The extracted operation log data is analyzed to specify the operation management procedure used when the execution control module stops and a returning part in the specified operation management procedure is specified based on the extracted operation log data and communication log data. Therefore, it is possible to apply the second embodiment when a plurality of operation management procedures are simultaneously executed and when a plurality of execution control functions, which execute different operation management procedures, respectively, are operated. It is possible to efficiently return a state of work that stops because of unexpected occurrence of a failure or the like to a state of the work under execution.

In the embodiments described above, the operation log data and the communication log data can be managed in a latest state.

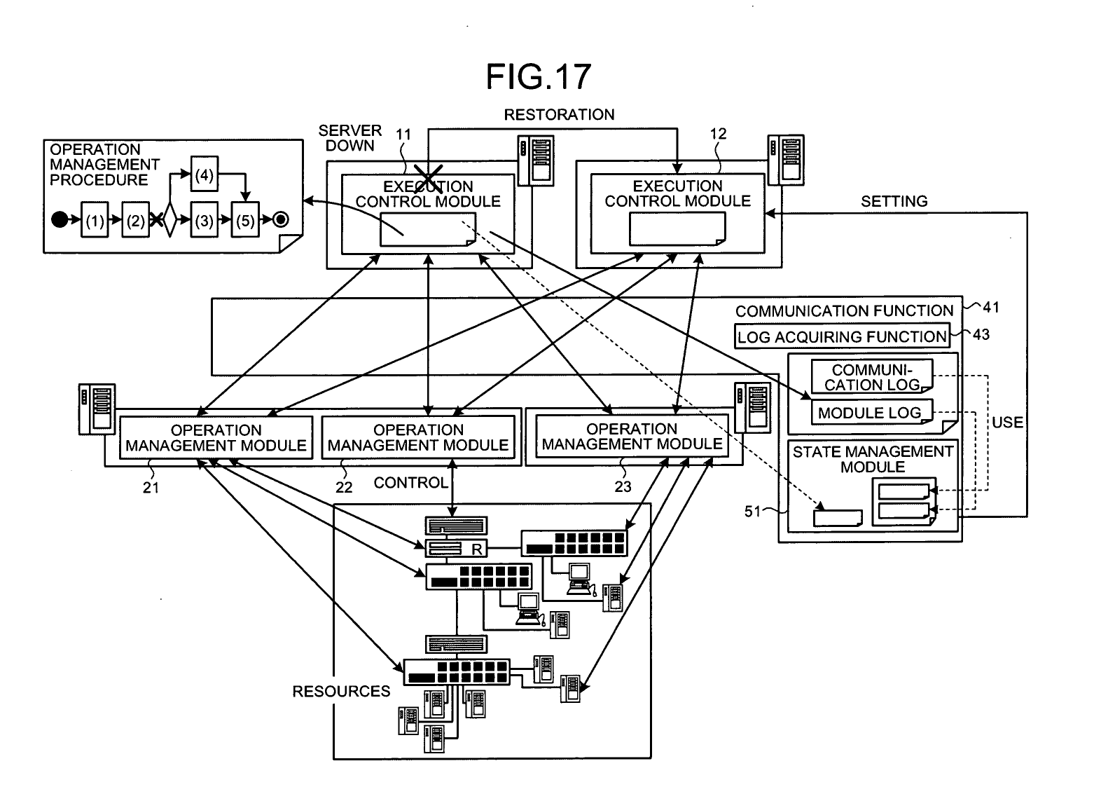

As shown in FIG. 17, an information system according to a third embodiment of the present invention has the structure basically the same as that of the information system according to the embodiments described above except points explained below.

A log acquiring function 43 acquires operation log data written by the execution control module 11 and communication log data concerning content of communication performed between the execution control module 11 and the respective operation management modules (21, 22, and 23).

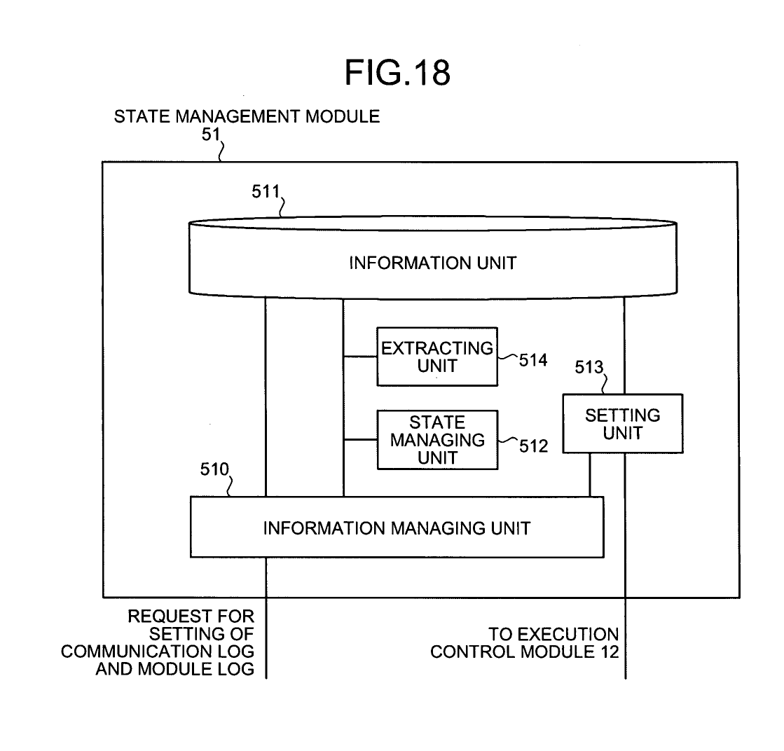

As shown in FIG. 18, a state management module 51 includes an information managing unit 510, an information unit 511, a state managing unit 512, a setting unit 513, and an extracting unit 514.

The information managing unit 510 acquires respective operation management procedures (e.g., the operation management procedure A and the operation management procedure B) from the execution control module and registers the operation management procedures in the information unit 511 in advance. The information managing unit 510 registers an area for registering states of and information on the respective operation management procedures in the state managing unit 512. Every time new operation log data and communication log data are acquired by the log acquiring function 43, the information managing unit 510 acquires the operation log data and the communication log data from the log acquiring function 43 and updates the states of and the information on the respective operation management procedures managed by the state managing unit 512.

The information managing unit 510 is requested to start the execution control module 12 instead of the execution control module 11 that stops because of server down or the like and set latest information on the execution control module 11 in the execution control module 12. The information managing unit 510 acquires a latest state of and latest information on the execution control module 11 from the state managing unit 512. The information managing unit 510 requests the setting unit 513 to set the latest state on and the latest information on the execution control module 11, which are acquired from the state managing unit 512, in the execution control module 12.

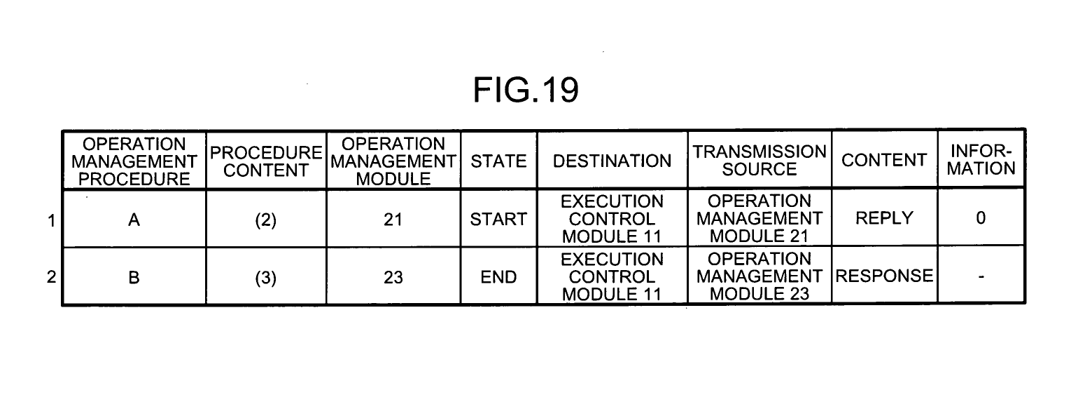

As shown in FIG. 19 as an example, the state managing unit 512 manages latest states of and latest information on the respective operation management procedures (e.g., the operation management procedure A and the operation management procedure B). The setting unit 513 receives the request from the information managing unit 510. The setting unit 513 sets the latest state of and the latest information on the execution control module 11 in the execution control module 12.

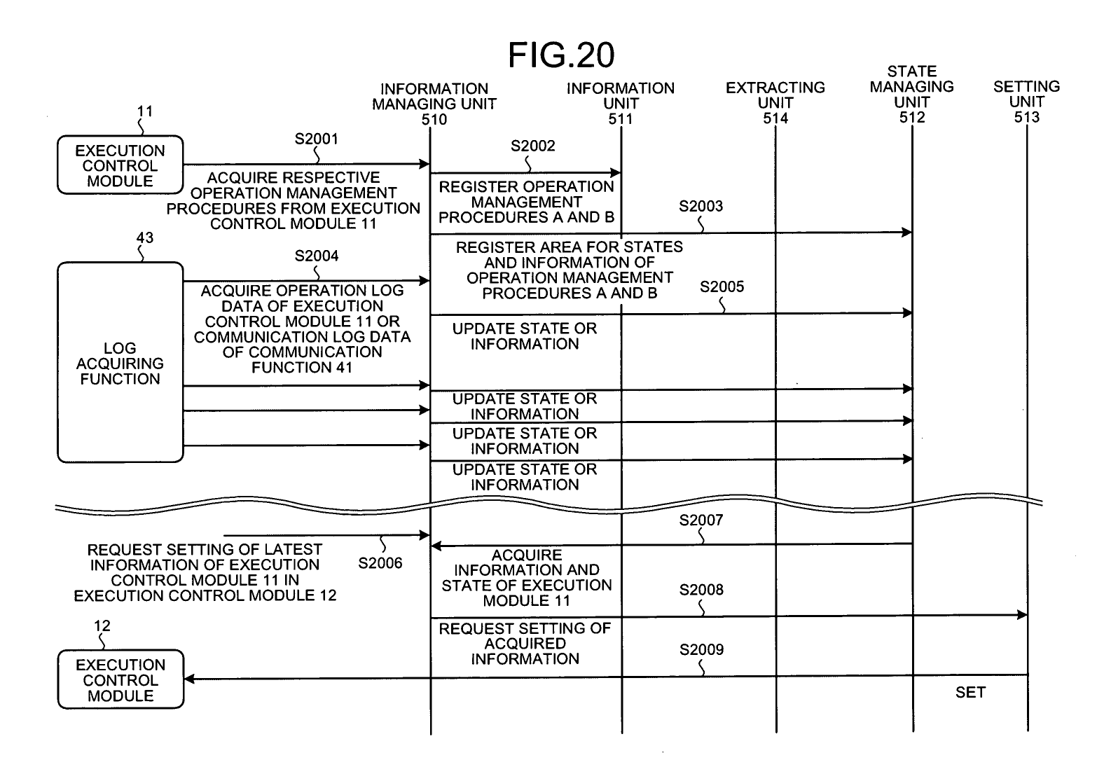

FIG. 20 is a sequence chart for explaining a flow of processing of the information system according to the third embodiment.

As shown in FIG. 20, the information managing unit 510 acquires the respective operation management procedures (e.g., the operation management procedure A and the operation management procedure B) from the execution control module (step S2001) and registers the operation management procedures in the information unit 511 in advance (step S2002).

The information managing unit 510 registers an area for registering states of and information on the respective operation management procedures in the state managing unit 512 (step S2003). Every time new operation log data and communication log data are acquired by the log acquiring function 43, the information managing unit 510 acquires the operation log data and the communication log data from the log acquiring function 43 (step S2004). The information managing unit 510 updates the states of and the information on the respective operation management procedures managed by the state managing unit 512 (step S2005).

The information managing unit 510 is requested to start the execution control module 12 instead of the execution control module 11 that stops because of server down or the like and set latest information on the execution control module 11 in the execution control module 12 (step S2006). Then, the information managing unit 510 acquires a latest state of and latest information on the execution control module 11 from the state managing unit 512 (step S2007). The information managing unit 510 requests the setting unit 513 to set the latest state of and the latest information on the execution control module 11, which are acquired from the state managing unit 512, in the execution control module 12 (step S2008).

In response to the request from the information managing unit 510, the setting unit 513 sets the latest state of and the latest information on the execution control module 11 in the execution control module 12 (step S2009).

As explained above, every time new operation log data and communication log data are acquired by the log acquiring function 43, the information managing unit 510 updates the states of and the information on the respective operation management procedures managed by the state managing unit 512. However, the present invention is not limited to this method. The states of and the information on the respective operation management procedures managed by the state managing unit 512 can be updated at a fixed interval or an indefinite interval (or an arbitrary interval). Processing for updating the states of and the information on the respective operation management procedures at a fixed interval (or an arbitrary interval) is different from the processing explained above in points explained below.

The information managing unit 510 acquires operation log data and communication log data from the log acquiring function 43 at a fixed interval (or an arbitrary interval) (step S2104) and registers the operation log data and the communication log data in the information unit 511 (step S2105). The information managing unit 510 requests the extracting unit 514 to update the states of and the information on the respective operation management procedures managed by the state managing unit 512 (step S2106).

In response to the request from the information managing unit 510, the extracting unit 514 acquires newly registered log data from the information unit 511 (step S2107). The extracting unit 514 extracts a state and information for each of the operation management procedures from the log data (step S2108) and updates the states of and the information on the respective operation management procedures managed by the state managing unit 512 (step S2109).

As described above, according to the third embodiment, by updating the states of and the information on the respective operation management procedure, it is possible to minimize managed information and efficiently return the system to a state of work under execution.

The embodiments of the present invention have been explained. However, the present invention can be carried out in various different forms other than the embodiments. Other embodiments included in the present invention are explained below.

The respective components of the information systems according to the embodiments shown in FIGS. 2 and 17 are functionally conceptual and do not always have to be physically constituted as shown in the figures. In other words, specific forms of distribution and integration of the respective functions constituting the information systems according to the embodiments are not limited to those shown in the figures. All or a part of the functions can be functionally or physically distributed or integrated in an arbitrary unit according to various loads, states of use, and the like.

All of the respective functions of the execution control modules 11 and 12, the operation management modules 21, 22, and 23, the setting module 32, the communication function 41, and the communication-log acquiring function 42 can be mounted on an identical personal computer or workstation. The functions can be mounted on separate personal computers or personal stations. The functions can be arbitrarily combined and mounted on a plurality of personal computers or work stations.

Moreover, the respective functions of the execution control modules 11 and 12, the operation management modules 21, 22, and 23, the setting module 32, the communication function 41, and the communication-log acquiring function 42 can be implemented by hardware or software or can be implemented by a combination of hardware and software.

According to an embodiment of the present invention, when the operation management functions execute cooperative work according to an instruction from the execution control function, communication history information concerning communication performed between the operation management functions and the execution control function is acquired and stored in the storing unit. When the execution control function stops while the cooperative work is executed by the operation management functions, returning parts in work content and work order set in operation management information is specified based on the communication history information and operation history information stored in the storing unit. According to the specified returning parts, the information system is returned to a state of work at the stop of the execution control function. Therefore, it is possible to efficiently return a state of work that stops because of unexpected occurrence of a failure or the like to a state of the work under execution. For example, when the execution control function stops immediately after a resource securing request for adding servers is transmitted from the execution control function to the management operation function, since a response from the operation management function cannot be received, it is impossible to judge whether resources are secured by the operation management function. When the communication history information is acquired as described above, it is possible to judge that resources are already secured by the operation management function. Therefore, it is unnecessary to perform resource securing work for adding servers again from a resource securing request and it is possible to efficiently return the system to a state of the work under execution (e.g., a state after securing of resources).

According to an embodiment of the present invention, the operation history information and the communication history information include identification information given to the operation management functions to uniquely identify the operation management functions. When the execution control function stops while cooperative work is executed by the operation management functions, the operation history information and the communication history information are extracted from each piece of the identification information. The extracted operation history information is analyzed to specify the operation management information used when the execution control function stops. A returning part in the specified operation management information is specified based on the extracted operation history information and communication history information. Therefore, it is possible to apply the present invention when a plurality of operation management procedures are simultaneously executed and when a plurality of execution control functions, which execute different operation management procedures, respectively, are operated. It is possible to efficiently return a state of work that stops because of unexpected occurrence of a failure or the like to a state of the work under execution.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for enabling recovery of an information system including an operation management function and an execution control function, the operation management function executing work according to an instruction from the execution control function, the execution control function controlling the operation management function to execute the work based on operation management information defining work content and work order for the work, the computer program causing a computer to execute:
acquiring, when the operation management function executes the work according to the instruction from the execution control function, communication history information concerning communication performed between the operation management functions and the execution control function;
storing the communication history information;
specifying, when the execution control function stops while the work is executed by the operation management function, a returning location in the work content and the work order, based on operation history information of the execution control function and the communication history information; and
returning, according to the returning location, the information system to a state of work at the stop of the execution control function.

2. The computer-readable recording medium according to claim 1, wherein
the operation history information and the communication history information include identification information to uniquely identify the operation management information, and
the computer program further causes the computer to execute:
extracting, when the execution control function stops while the work is executed by the operation management function, the operation history information and the communication history information for each piece of the operation management information based on the identification information;
analyzing the operation history information extracted for each piece of the operation management information;
specifying the operation management information used at the stop of the execution control function; and
specifying, based on the operation history information and the communication history information, a returning location in the operation management information.

3. The computer-readable recording medium according to claim 2, wherein the computer program further causes the computer to execute:
managing, for each piece of the operation management information, latest information concerning the work performed according to the operation management information;
updating, every time the operation history information and the communication history information are acquired, the latest information based on the operation history information and the communication history information; and
returning the information system to a state of work at the stop of the execution control function based on the latest information.

4. The computer-readable recording medium according to claim 3, wherein the operation history information and the communication history information are acquired for each predetermined time to update the latest information.

5. A work state returning method for enabling recovery of an information system including an operation management function and an execution control function, the operation management function executing work according to an instruction from the execution control function, the execution control function controlling the operation management function to execute the work based on operation management information defining work content and work order for the work, the method causing a computer to execute:
acquiring, when the operation management function executes the work according to the instruction from the execution control function, communication history information concerning communication performed between the operation management functions and the execution control function;
storing the communication history information;
specifying, when the execution control function stops while the work is executed by the operation management function, a returning location in the work content and the work order, based on operation history information of the execution control function and the communication history information; and
returning, according to the returning location, the information system to a state of work at the stop of the execution control function.

6. The work state returning method according to claim 5, wherein
the operation history information and the communication history information include identification information to uniquely identify the operation management information, and
the method further causes the computer to execute:
extracting, when the execution control function stops while the work is executed by the operation management function, the operation history information and the communication history information for each piece of the operation management information based on the identification information;
analyzing the operation history information extracted for each piece of the operation management information;
specifying the operation management information used at the stop of the execution control function; and
specifying, based on the operation history information and the communication history information, a returning location in the operation management information.

7. The work state returning method according to claim 6, wherein the computer program further causes the computer to execute:
managing, for each piece of the operation management information, latest information concerning the work performed according to the operation management information;
updating, every time the operation history information and the communication history information are acquired, the latest information based on the operation history information and the communication history information; and
returning the information system to a state of work at the stop of the execution control function based on the latest information.

8. The work state returning method according to claim 7, wherein the operation history information and the communication history information are acquired for each predetermined time to update the latest information.

9. A work state returning apparatus for enabling recovery of an information system including an operation management function and an execution control function, the operation management function executing work according to an instruction from the execution control function, the execution control function controlling the operation management function to execute the work based on operation management information defining work content and work order for the work, the apparatus comprising:
a communication-history-information acquiring unit that acquires, when the operation management function executes the work according to the instruction from the execution control function, communication history information concerning communication performed between the operation management function and the execution control function;
a communication-history-information storing unit that stores therein the communication history information acquired by the communication-history-information acquiring unit;
a returning-part specifying unit that specifies, when the execution control function stops while the work is executed by the operation management function, a returning location in the work content and the work order, based on operation history information of the execution control function and the communication history information stored in the communication-history-information storing unit; and
a work-state returning unit that returns, according to the returning location specified by the returning-part specifying unit, the information system to a state of work at the stop of the execution control function.

10. The work state returning apparatus according to claim 9, wherein the operation history information and the communication history information include identification information to uniquely identify the operation management information, the apparatus further comprising:
an information extracting unit that extracts, when the execution control function stops while the work is executed by the operation management function, the operation history information and the communication history information for each piece of the operation management information based on the identification information; and
an operation-management-information specifying unit that analyzes the operation history information extracted for each piece of the operation management information by the information extracting unit and specifies the operation management information used at the stop of the execution control function, wherein
the returning-part specifying unit specifies, based on the operation history information and the communication history information extracted by the information extracting unit, a returning location in the operation management information specified by the operation-management-information specifying unit.

11. The work state returning apparatus according to claim 10, further comprising:
a latest-information managing unit that manages, for each piece of the operation management information, latest information concerning the work performed according to the operation management information; and
an information updating unit that updates, every time the operation history information and the communication history information are acquired, the latest information managed by the latest-information managing unit based on the operation history information and the communication history information, wherein
the work-state returning unit returns, based on the latest information managed by the latest-information managing unit, the information system to the state of work at the stop of the execution control function.

12. The work state returning apparatus according to claim 11, wherein the information updating unit acquires the operation history information and the communication history information for each predetermined time and updates the latest information managed by the latest-information managing unit.
